(19) United States
(12) Patent Application Publication
(10) Pub. No.: US 2014/0195583 A1
(43) Pub. Date: Jul. 10, 2014

(54) MULTIMEDIA PLAYBACK APPARATUS AND MULTIMEDIA FILE PREFETCHING METHOD

(71) Applicants: Chen-Li Kao, Taipei City (TW); Chia-Ming Huang, Taipei City (TW)

(72) Inventors: Chen-Li Kao, Taipei City (TW); Chia-Ming Huang, Taipei City (TW)

(73) Assignee: COMPAL ELECTRONICS, INC., Taipei City (TW)

(21) Appl. No.: 13/792,226

(22) Filed: Mar. 11, 2013

(30) Foreign Application Priority Data
Jan. 8, 2013 (TW) 102100593

(51) Int. Cl. H04L 29/08

(52) U.S. Cl. CPC H04L 67/02
USPC 709/201

(57) ABSTRACT

A multimedia playback apparatus and a multimedia file prefetching method are provided. In the method, a first multimedia file is downloaded and played first. Next, at least one playlist is read, and at least one second multimedia file sorted after the first multimedia file in the at least one playlist is searched. Then, the at least one second multimedia file is prefetched.

### CROSS-REFERENCE TO RELATED APPLICATION

This application claims the priority benefit of Taiwan application serial no. 102100593, filed on Jan. 8, 2013. The entirety of the above-mentioned patent application is hereby incorporated by reference herein and made a part of this specification.

### BACKGROUND OF THE INVENTION

1. Field of the Invention

The present invention generally relates to a file playback apparatus and method, in particular, to a method and an apparatus for prefetching a multimedia file according to a playlist.

2. Description of Related Art

For convenience in file management and storage space saving on a client apparatus, one of the preferred approaches is to store files altogether in a fixed device so to provide a plurality of devices for freely accessing the stored files. Hence, free or paid network storage space has been currently provided by many services so that a user may upload files such as music, pictures, or videos to a network server. When such files are needed, the files may be downloaded via the network server and displayed or played on the client apparatus.

As a network bandwidth increases, the download speed of multimedia files is able to catch up the playback speed. Thus, while a client apparatus is downloading files, the downloaded files may be played simultaneously so that an online video stream may be played in real-time. In such playback approach, a browser is adapted to connect to the uniform resource locator (URL) of a video stream, and an application program interface (API) at a lower layer such as DirectX is called via the browser to assist in decoding the downloaded video stream data in order to recover it back to a video file to be played by the client apparatus.

Nonetheless, network traffic may occur since the network download speed is sometimes affected by factors such as the number of people on the network, the efficiency of a client apparatus, or the efficiency of a network server. By using the online playback approach, a playback delay may occur due to network traffic and may further affect the user's viewing quality. Therefore, a better file download mechanism needs to be provided such that multimedia files possibly to be played by the user are prefetched so as to improve the playback efficiency of the multimedia files.

### SUMMARY OF THE INVENTION

Accordingly, the present invention is directed to a multimedia playback apparatus and a multimedia file prefetching method able to improve the playback efficiency of multimedia files.

The present invention is directed to a multimedia file prefetching method adapted for downloading and playing at least one multimedia file by an electronic apparatus. In the method, a first multimedia file is downloaded and played. Next, at least one playlist is read, and at least one second multimedia file sorted after the first multimedia file in the at least one playlist is searched. Then, the at least one second multimedia file is prefetched.

According to an embodiment of the present invention, in the step of downloading and playing the first multimedia file, a playback operation on the first multimedia file is received so as to execute a default playback program for playing the first multimedia file, the playlist including the first multimedia file under the playback program is opened, and the first multimedia file is downloaded and played.

According to an embodiment of the present invention, in the step of downloading and playing the first multimedia file, a playback operation on the playlist including the first multimedia file is received so as to execute a playback program for opening the playlist, the playlist is opened, and a selection operation of the first multimedia file in the playlist is received so as to download and play the first multimedia file.

According to an embodiment of the present invention, in the step of reading the at least one playlist, the at least one playlist stored in the electronic apparatus or a server on a network is read.

According to an embodiment of the present invention, in the steps of reading the at least one playlist, searching for the at least one second multimedia file sorted after the first multimedia file in the at least one playlist, and prefetching the at least one multimedia file, the at least one second multimedia file sorted after the first multimedia file is searched in the playlist opened while the first multimedia file is being played, and the at least one second multimedia file is downloaded in top priority.

According to an embodiment of the present invention, in the steps of reading the at least one playlist, searching for the at least one second multimedia file sorted after the first multimedia file in the at least one playlist, and prefetching the at least one multimedia file, all of the at last one playlist under a playback program for playing the first multimedia file is read, the at least one second multimedia file sorted after the first multimedia file on the read at least one playlist is searched, and the at least one second multimedia file is download in top priority.

According to an embodiment of the present invention, in the step of prefetching the at least one second multimedia file, a download bandwidth for downloading the first multimedia file is calculated, a remaining bandwidth is calculated by subtracting the download bandwidth from a total bandwidth, and the remaining bandwidth is allocated for prefetching the at least one second multimedia file.

According to an embodiment of the present invention, in the step of allocating the remaining bandwidth for prefetching the at least one second multimedia file, the at least one second multimedia file is downloaded sequentially by using the remaining bandwidth according to a priority order of the at least one second multimedia file to be prefetched.

According to an embodiment of the present invention, in the step of allocating the remaining bandwidth for prefetching the at least one second multimedia file, all or a portion of the at least one second multimedia file is downloaded simultaneously by using the remaining bandwidth.

The present invention is directed to a multimedia playback apparatus including a network connecting unit, a storage unit, and a playback unit. The network connecting unit is used for connecting with a server via a network and downloading a first multimedia file. The storage unit is used for storing the first multimedia file downloaded by the network connecting unit. The playback unit is coupled to the network connecting unit and the storage unit and is used for playing the first multimedia file, reading at least one playlist so as to search for at least one second multimedia file sorted after the first multimedia file in the at least one playlist, and prefetching the at least one second multimedia file via the network connecting unit.

According to an embodiment of the present invention, the multimedia playback apparatus further includes an operating unit for receiving an playback operation on the first multimedia file so as to allow the playback unit to execute a default playback program for playing the first multimedia file, open the playback program comprising the playlist of the first multimedia file, and download and play the first multimedia file.

According to an embodiment of the present invention, the operating unit further receives a playback operation on the playlist including the first multimedia file so as to allow the playback unit to execute a playback program for opening the playlist to open the playlist. The operating unit further receives a selection operation on the first multimedia file in the playlist so as to download and play the first multimedia file.

According to an embodiment of the present invention, the storage unit stores the at least one playlist provided for the playback unit to read.

According to an embodiment of the present invention, the playback unit reads the at least one playlist stored in the server via the network connecting unit.

According to an embodiment of the present invention, the playback unit searches for the at least one second multimedia file sorted after the first multimedia file in the at least one playlist opened while the first multimedia file is being played and downloads the at least one playlist via the network connecting unit in top priority.

According to an embodiment of the present invention, the playback unit reads all of the at least one playlist under a playback program for playing the first multimedia file, searches for the at least one second multimedia file sorted after the first multimedia file in the read at least one playlist, and downloads the at least one second multimedia file via the network connecting unit in top priority.

According to an embodiment of the present invention, the playback unit calculates a download bandwidth for downloading the first multimedia file, calculates a remaining bandwidth of the electronic apparatus by subtracting the download bandwidth from a total bandwidth, and allocates the remaining bandwidth so as to prefetch the at least one second multimedia file via the network connecting unit.

According to an embodiment of the present invention, the playback unit downloads the at least one second multimedia file sequentially by using the remaining bandwidth according to a priority order for prefetching the at least one second multimedia file or downloads all or a portion of the at least one second multimedia file simultaneously by using the remaining bandwidth.

According to an embodiment of the present invention, the playlist includes a file with a filename extension of asx, wpl, pls, m3u, zpl, bio, fpl, kpl, pla, plc, smil, or vlc.

To sum up, in the multimedia playback apparatus and the multimedia file prefetching method of the present invention, when a multimedia file is played by the user, a playlist including the multimedia file is read, and other multimedia files sorted after the multimedia file are searched from the playlist and further prefetched.

Accordingly, a next multimedia file may be quickly switched to and played so that the playback efficiency of the multimedia files may be improved.

Several exemplary embodiments accompanied with figures are described in detail below to further describe the disclosure in details.

### BRIEF DESCRIPTION OF THE DRAWINGS

FIG. 1 is a block diagram of a multimedia playback apparatus according to an embodiment of the present invention.

FIG. 2 is a flow chart of a multimedia file prefetching method according to an embodiment of the present invention.

FIG. 3 is a flow chart of a multimedia file prefetching method according to an embodiment of the present invention.

FIG. 4 is a flow chart of a multimedia file prefetching method according to an embodiment of the present invention.

### DESCRIPTION OF THE EMBODIMENTS

For convenience in managing and playing multimedia files, when a user uses a multimedia playback apparatus, he/she normally constructs a plurality of playlists based on preferences or file types so that the multimedia playback apparatus may continuously play different multimedia files. Such playlists not only record a playback order of the multimedia files but also represent viewing or listening habits of the user. Therefore, it is not difficult to determine a next multimedia file to be possibly played by the user from the playlists. In accordance with such concept, when the user chooses to play a multimedia file, the other multimedia files sorted thereafter are searched in a pre-constructed playlist and further prefetched in the present invention. Accordingly, subject to user demand, the multimedia files may be played immediately and the playback efficiency of the multimedia files may be improved.

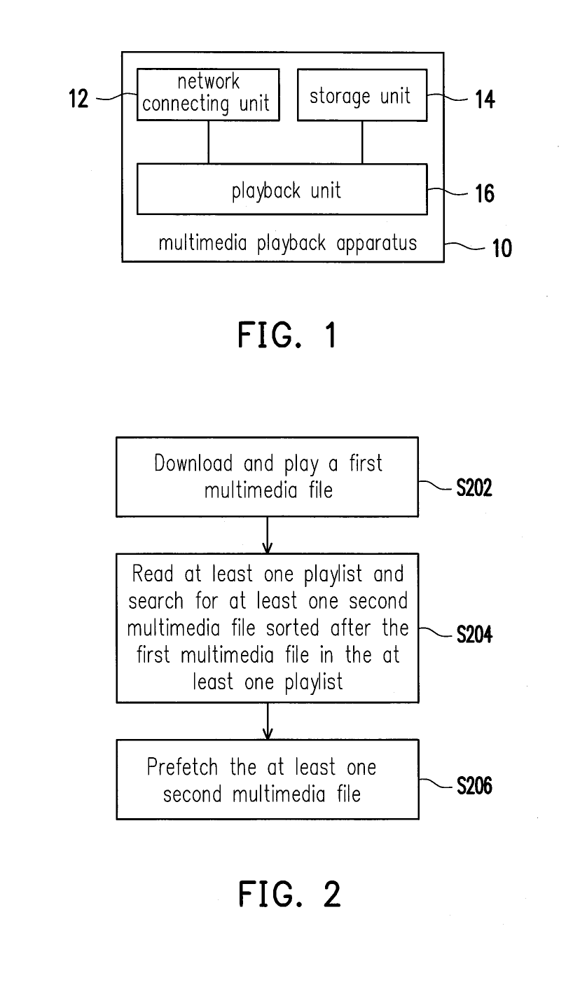

FIG. 1 is a block diagram of a multimedia playback apparatus according to an embodiment of the present invention. Referring to FIG. 1, a multimedia playback apparatus 10 in the present embodiment may be an electronic apparatus such a cellular phone, a smart phone, a personal digital assistant (PDA), a PDA cellular phone, a tablet computer, a notebook computer, or a desktop computer. The multimedia playback apparatus 10 includes a network connecting unit 12, a storage unit 14, and a playback unit 16, wherein the functions thereof are described as follows.

The network connecting unit 12 is, for example, a network interface card supporting a communication protocol such as the Institute of Electrical and Electronics Engineers (IEEE) 802.11b/g/n. The network connecting unit 12 may allow the multimedia playback apparatus 10 to connect to an external server via network connection so as to download multimedia files from the server.

The storage unit 14 is, for example, a random access memory (RAM), a flash memory, or a hard drive, used for storing the multimedia files downloaded from the network connecting unit 12.

The playback unit 16 is, for example, a central processing unit (CPU), a microprocessor, a digital signal processor (DSP), an application specific integrated circuit (ASIC), or the like. The playback unit 16 is coupled to the network connecting unit 12 and the storage unit 14. The playback unit 16 is able to download the multimedia files to the storage unit 14 by connecting to the server on the network via the network connecting unit 12 and play the multimedia files stored in the storage unit 14.

The playback unit 16 may also prefetch other multimedia files from the server according to a playlist subject to the playback demand from the user.

To be specific, FIG. 2 is a flow chart of a multimedia file fetching method according to an embodiment of the present invention. Referring to FIG. 2, the method in the present embodiment is suited for the multimedia playback apparatus 10 in the aforementioned embodiment. The detailed steps of the prefetching method in the present invention will be illustrated along with each component in the multimedia playback apparatus 10 as follows.

First, the multimedia playback apparatus 10 is connected to a server via the network connecting unit 12 so as to download a first multimedia file, and the downloaded first multimedia file is played by the playback unit 16 (Step S202). According to, for example, a multimedia file opened directly by the user or selected from the playlist, the multimedia playback apparatus 10 is connected to the server via the network connecting unit 12 so as to download the multimedia file and store it in the storage unit 14 so as to provide the playback unit 16 for storing and playing the multimedia file.

To be specific, in an embodiment, the multimedia playback apparatus 10 may receive a playback operation of the user on a multimedia file via an operating unit such as a keyboard, a mouse, a touch panel. By that means, the playback unit 16 may execute a default playback program for playing the multimedia file and open the playlist including the multimedia file under the playback program so as to download and play the multimedia file.

In another embodiment, the multimedia playback apparatus 10 may receive the playback operation of the user on the playlist via the operating unit so that the playback unit 16 may execute the playback program for opening the playlist and then open the playlist. Then, the operating unit is further used to receive a selection operation of the user on a multimedia file in the playlist, and accordingly the playback unit 16 may download the multimedia file from the server via the network connecting unit 12 and play the multimedia file.

Then, the playback unit 16 may read at least one playlist and search for at least one second multimedia file sorted after the first multimedia file in the at least one playlist (Step S204). In an embodiment, the aforementioned playlist is, for example, stored in the storage unit 14 of the multimedia playback apparatus 10 so that the playback unit 16 may read the playlist directly and search for a next multimedia file to be possibly played. In another embodiment, the aforementioned playlist is, for example, stored in a network server so that the playback unit 16 may download the playlist via the network connecting unit 12 and search for a next multimedia file to be possibly played. The aforementioned playlist includes a file with a filename extension of asx, wpl, pls, m3u, zpl, bio, fpl, kpl, pla, plc, smil, or vlc, and yet the present invention is not limited thereto.

After a list of the at least one second multimedia file is obtained, the playback unit 16 may prefetch the second multimedia file by using a remaining bandwidth from downloading the first multimedia file while the first multimedia file is being played

(Step S206). To be specific, the playback unit 16 may, for example, calculate a download bandwidth for downloading the first multimedia file. Such download bandwidth is, for example, the minimum data amount required for smoothly playing the first multimedia file. After a total bandwidth obtained by the multimedia playback apparatus 10 is subtracted by the download bandwidth, the remaining bandwidth may be allocated for prefetching the at least one second multimedia file. The download bandwidth may be adjusted dynamically by the playback unit 16 based on an actual playback condition to ensure that the first multimedia file is being played smoothly.

Additionally, when the remaining bandwidth is allocated to the playback unit 16, the plurality of searched second multimedia files may be downloaded either sequentially or simultaneously based on different playback demands from the user. To be specific, in an embodiment, the playback unit 16 may download the plurality of second multimedia files sequentially by using the remaining bandwidth according to a priority order of the second multimedia files to be prefetched. In another embodiment, the playback unit 16 may download all or a portion of the second multimedia files simultaneously by using the remaining bandwidth according to the priority order of the second multimedia files to be prefetched as well. The priority order of the second multimedia files may be determined by the playlist opened or the playback program executed by the user, and the present invention is not limited thereto. An embodiment will be illustrated in detail for each case as follows.

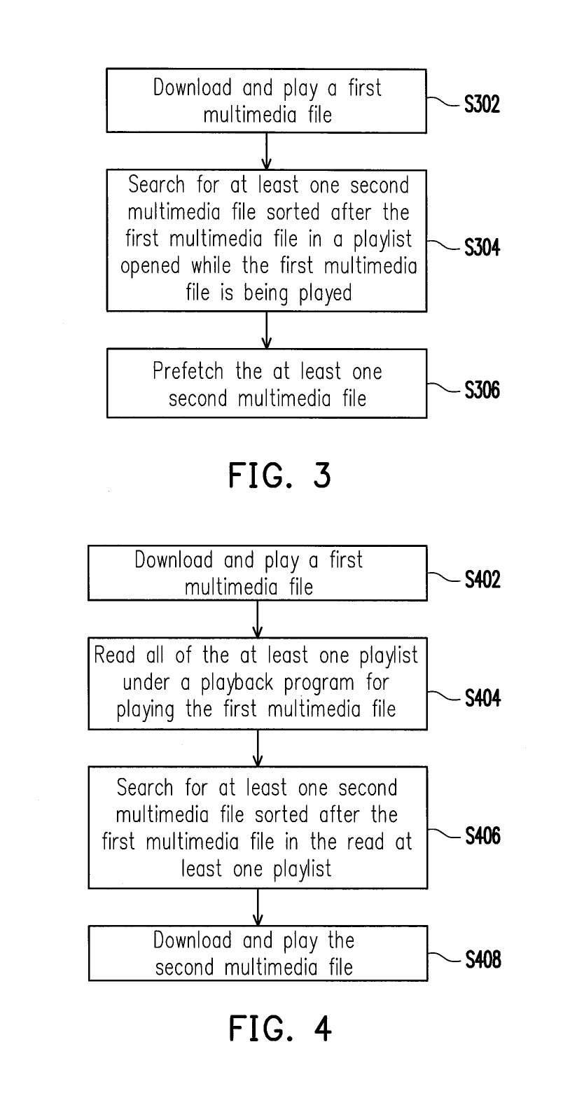

FIG. 3 is a flow chart of a multimedia file prefetching method according to an embodiment of the present invention. Referring to FIG. 3, the method in the present embodiment is suited for the multimedia playback apparatus 10 in the aforementioned embodiment. The detailed steps of the prefetching method in the present invention will be illustrated along with each component in the multimedia playback apparatus 10 as follows.

First, the multimedia playback apparatus 10 is connected to a server via the network connecting unit 12 so as to download a first multimedia file, and the downloaded first multimedia file is played by the playback unit 16 (Step S302).

Then, the playback unit 16 may search for at least one second multimedia file sorted after the first multimedia file in the at least one playlist (Step S304) and download the at least one second multimedia file in top priority via the network connecting unit 12 (Step S306). The opened playlist may be, for example, a playlist opened before the user plays the first multimedia file or a playlist opened by a playback program as soon as the user plays the first multimedia file. In other words, the playlist is a reference of playing the multimedia files currently executed by the playback program, and the multimedia files in the playlist are next multimedia files to be most possibly played by the user. By using the priority mechanism for downloading, the prefetched files may satisfy the playback demand from the user.

On the other hand, FIG. 4 is a flow chart of a multimedia file prefetching method according to an embodiment of the present invention. Referring to FIG. 4, the method in the present embodiment is suited for the multimedia playback apparatus 10 in the aforementioned embodiment. The detailed steps of the prefetching method in the present invention will be illustrated along with each component in the multimedia playback apparatus 10 as follows.

First, the multimedia playback apparatus 10 is connected to a server via the network connecting unit 12 so as to download a first multimedia file, and the downloaded first multimedia file is played by the playback unit 16 (Step S402).

Then, the playback unit 16 may read all playlists under playback programs capable of playing the first multimedia file (Step S404). Each of the playback programs may include a plurality of playlists, and the playlists may include the first multimedia file which is currently played. Multimedia files sorted after the first multimedia file in the playlists may be the next objects possibly played by the user.

Accordingly, the playback unit 16 may search for at least one second multimedia file sorted after the first multimedia file in the read playlists (Step S406) and download the at least one second multimedia file in top priority via the network connecting unit 12 (Step S408). By that means, even if the user switches the playlist used by the playback program, the playback unit 16 may use the prefetched files to satisfy the playback demand from the user subject to the multimedia files in the switched playlist.

To sum up, in the multimedia playback apparatus and the multimedia file prefetching method of the present invention, when a multimedia file is played by the user, a playlist may be read from the apparatus or an external server in which the playlist is stored. Other multimedia files sorted after the currently played multimedia file are searched from the playlist and further prefetched based on a current bandwidth. Through the aforementioned multimedia file prediction and download mechanism, a next multimedia file may be quickly switched to and played continuously so that the playback efficiency of the multimedia files may be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multimedia file prefetching method adapted for downloading and playing at least one multimedia file by an electronic apparatus, comprising:
downloading and playing a first multimedia file;
reading at least one playlist and searching for at least one second multimedia file sorted after the first multimedia file in the at least one playlist; and
prefetching the at least one second multimedia file.

2. The multimedia file prefetching method of claim 1, wherein the step of downloading and playing the first multimedia file comprises:
receiving a playback operation on the first multimedia file;
executing a default playback program for playing the first multimedia file; and
opening the playlist comprising the first multimedia file under the playback program, and downloading and playing the first multimedia file.

3. The multimedia file prefetching method of claim 1, wherein the step of downloading and playing the first multimedia file comprises:
receiving a playback operation on the playlist comprising the first multimedia file so as to execute a playback program for opening the playlist and open the playlist; and
receiving a selection operation on the first multimedia file in the playlist so as to download and play the first multimedia file.

4. The multimedia file prefetching method of claim 1, wherein the step of reading the at least one playlist comprises:
reading the at least one playlist stored in the electronic apparatus or in a server on a network.

5. The multimedia file prefetching method of claim 1, wherein the step of reading the at least one playlist, searching for the at least one second multimedia file sorted after the first multimedia file in the at least one playlist, and prefetching the at least one second multimedia file comprises:
searching for the at least one second multimedia file sorted after the first multimedia file in the playlist opened while the first multimedia file is being played and downloading the at least one second multimedia file in top priority.

6. The multimedia file prefetching method of claim 1, wherein the step of reading the at least one playlist, searching for the at least one second multimedia file sorted after the first multimedia file in the at least one playlist, and prefetching the at least one multimedia file comprises:
reading all of the at least one playlist under a playback program for playing the first multimedia file; and
searching for the at least one second multimedia file sorted after the first multimedia file in the read at least one playlist and downloading the at least one second multimedia file in top priority.

7. The multimedia file prefetching method of claim 1, wherein the step of prefetching the at least one second multimedia file comprises:
calculating a download bandwidth for downloading the first multimedia file;
calculating a remaining bandwidth by subtracting the download bandwidth from a total bandwidth; and
allocating the remaining bandwidth so as to prefetch the at least one second multimedia file.

8. The multimedia file prefetching method of claim 7, wherein the step of allocating the remaining bandwidth so as to prefetch the at least one second multimedia file comprises:
sequentially downloading the at least one second multimedia file by using the remaining bandwidth according to a priority order of the at least one second multimedia file to be prefetched.

9. The multimedia file prefetching method of claim 7, wherein the step of allocating the remaining bandwidth so as to prefetch the at least one second multimedia file comprises:
simultaneously downloading all or a portion of the at least one second multimedia file by using the remaining bandwidth.

10. A multimedia playback apparatus comprising:
a network connecting unit, configured to connect with a server via a network and download a first multimedia file;
a storage unit, configured to store the first multimedia file; and
a playback unit, coupled to the network connecting unit and the storage unit, and configured to play the first multimedia file, read at least one playlist so as to search for at least one second multimedia file sorted after the first multimedia file in the at least one playlist, and prefetch the at least one second multimedia file via the network connecting unit.

11. The multimedia playback apparatus of claim 10, further comprising:
an operating unit, configured to receive an playback operation on the first multimedia file so as to allow the playback unit to execute a default playback program for playing the first multimedia file, open the playlist comprising the first multimedia file under the playback program, and download and play the first multimedia file.

12. The multimedia playback apparatus of claim 11, wherein the operating unit further receives a playback operation on the playlist comprising the first multimedia file so as to allow the playback unit to execute a playback program for opening the playlist to open the playlist, and receives a selection operation on the first multimedia file in the playlist so as to download and play the first multimedia file.

13. The multimedia playback apparatus of claim 10, wherein the storage unit stores the at least one playlist provided for the playback unit to read.

14. The multimedia playback apparatus of claim 10, wherein the playback unit reads the at least one playlist stored in the server via the network connecting unit.

15. The multimedia playback apparatus of claim 10, wherein the playback unit searches for the at least one second multimedia file sorted after the first multimedia file in the at least one playlist opened while the first multimedia file is being played and downloads the at least one playlist via the network connecting unit in top priority.

16. The multimedia playback apparatus of claim 10, wherein the playback unit reads all of the at least one playlist under a playback program for playing the first multimedia file, searches for the at least one second multimedia file sorted after the first multimedia file in the read at least one playlist, and downloads the at least one second multimedia file via the network connecting unit in top priority.

17. The multimedia playback apparatus of claim 10, wherein the playback unit calculates a download bandwidth for downloading the first multimedia file, calculates a remaining bandwidth of the electronic apparatus by subtracting the download bandwidth from a total bandwidth, and allocates the remaining bandwidth so as to prefetch the at least one second multimedia file via the network connecting unit.

18. The multimedia playback apparatus of claim 17, wherein the playback unit downloads the at least one second multimedia file sequentially by using the remaining bandwidth according to a priority order of the at least one second multimedia file to be prefetched.

19. The multimedia playback apparatus of claim 17, wherein the playback unit downloads all or a portion of the at least one second multimedia file simultaneously by using the remaining bandwidth.

20. The multimedia playback apparatus of claim 10, wherein the playlist comprises a file with a filename extension of asx, wpl, pls, m3u, zpl, bio, fpl, kpl, pla, plc, smil, or vlc.
